(19) United States
(12) Patent Application Publication
(10) Pub. No.: US 2024/0284346 A1
(43) Pub. Date: Aug. 22, 2024

(54) GEOGRAPHY BASED TRANSMIT POWER BACKOFF IN A CELLULAR VEHICLE-TO-EVERYTHING (CV2X) SYSTEM

(71) Applicant: QUALCOMM Incorporated, San Diego, CA (US)

(72) Inventors: Jiazhi LIANG, Shanghai (CN); Balasubramanian RAMACHANDRAN, Hyderabad (IN); Shuyang YIN, Beijing (CN); Tangtang WU, Shanghai (CN)

(21) Appl. No.: 18/568,425

(22) PCT Filed: Aug. 12, 2021
(86) PCT No.: PCT/CN2021/112196

§ 371 Date: Dec. 8, 2023

(51) Int. Cl. H04W 52/28; H04W 52/36

(52) U.S. Cl. CPC H04W 52/283; H04W 52/367

(57) ABSTRACT

Certain aspects of the present disclosure provide techniques and apparatus for geography-based transmit power backoff. A method that may be performed by a user equipment (UE) includes identifying a region in which the UE is located and selecting a first maximum power reduction value associated with the region. The method further includes determining a transmit power for a signal based at least in part on the selected first maximum power reduction value and transmitting the signal at the transmit power.

### BACKGROUND

### Field of the Disclosure

Aspects of the present disclosure relate to wireless communications, and more particularly, to techniques for cellular vehicle-to-everything (CV2X) communications.

### Description of Related Art

Wireless communication systems are widely deployed to provide various telecommunication services such as telephony, video, data, messaging, broadcasts, etc. Modern wireless communication devices (such as cellular telephones) are generally required to meet radio frequency (RF) emission requirements set by domestic and international standards and regulations. To ensure compliance with the standards, such devices must currently undergo an extensive certification process prior to being shipped to market. To ensure that a wireless communication device complies with an RF emissions limit, techniques have been developed to enable the wireless communication device to assess the RF emissions from the wireless communication device in real time and adjust the transmission power of the wireless communication device accordingly to comply with the RF emissions limit.

### SUMMARY

The systems, methods, and devices of the disclosure each have several aspects, no single one of which is solely responsible for its desirable attributes. After considering this discussion, and particularly after reading the section entitled “Detailed Description” one will understand how the features of this disclosure provide desirable cellular vehicle-to-everything (CV2X) communications.

Certain aspects of the subject matter described in this disclosure can be implemented in a method for wireless communication by a user equipment (UE). The method generally includes identifying a region in which the UE is located and selecting a first maximum power reduction value associated with the region. The method further includes determining a transmit power for a signal based at least in part on the selected first maximum power reduction value and transmitting the signal at the transmit power.

Certain aspects of the subject matter described in this disclosure can be implemented in an apparatus for wireless communication. The apparatus generally includes a memory, a processor, and a transceiver. The processor is coupled to the memory, and the processor and memory are configured to identify a region in which the apparatus is located, select a first maximum power reduction value associated with the region, and determine a transmit power for a signal based at least in part on the selected first maximum power reduction value. The transceiver is configured to transmit the signal at the transmit power.

Certain aspects of the subject matter described in this disclosure can be implemented in an apparatus for wireless communication. The apparatus generally includes means for identifying a region in which the apparatus is located; means for selecting a first maximum power reduction value associated with the region; means for determining a transmit power for a signal based at least in part on the selected first maximum power reduction value; and means for transmitting the signal at the transmit power.

Certain aspects of the subject matter described in this disclosure can be implemented in a computer-readable medium. The computer-readable medium has instructions stored thereon for identifying a region in which an apparatus is located; selecting a first maximum power reduction value associated with the region; determining a transmit power for a signal based at least in part on the selected first maximum power reduction value; and transmitting the signal at the transmit power.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain aspects of this disclosure and the description may admit to other equally effective aspects.

FIG. 1 is a block diagram conceptually illustrating an example wireless communication network, in accordance with certain aspects of the present disclosure.

FIG. 2 is a block diagram conceptually illustrating a design of an example base station (BS) and user equipment (UE), in accordance with certain aspects of the present disclosure.

FIG. 3 is an example frame format for certain wireless communication systems (e.g., new radio (NR)), in accordance with certain aspects of the present disclosure.

FIGS. 4A and 4B are diagrams of example vehicle-to-everything (V2X) systems, in accordance with some aspects of the present disclosure.

FIG. 5 is a schematic diagram illustrating an example network of multiple cellular V2X (CV2X) devices operating in an unlicensed spectrum, in accordance with certain aspects of the present disclosure.

FIG. 6 is a block diagram of an example radio frequency (RF) transceiver circuit, in accordance with certain aspects of the present disclosure.

FIG. 7 is a flow diagram illustrating example operations for wireless communication by a UE, in accordance with certain aspects of the present disclosure.

FIG. 8 is a signaling flow diagram illustrating example signaling for geography-based transmit power backoff, in accordance with aspects of the present disclosure.

FIG. 9 is a signaling flow diagram illustrating example internal signaling at a UE for geography-based transmit power backoff, in accordance with aspects of the present disclosure.

FIG. 10 is a diagram of example location sources for a UE to use in determining its location, in accordance with certain aspects of the present disclosure.

FIG. 11 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for identifying the transmit power backoff in a cellular vehicle-to-everything (CV2X) system based on the geographic location of a CV2X user equipment. For example, the UE may identify a geographic region (e.g., the United State, China, the European Union) in which the UE is located, and the UE may select an additional maximum power reduction (A-MPR) value associated with the region, for example, from a list of regions with corresponding A-MPR values or parameters used to derive the A-MPR. With the selected A-MPR, the UE may determine a maximum transmit power, for example, within the bounds of Expression (1), where P_{CMAX_L,c} may be calculated using the A-MPR value. The UE may determine a transmit power in compliance with the configured maximum transmit power (e.g., P_{CMAX,c}) and/or other emission requirements, such as RF exposure limits.

The following description provides examples of cellular vehicle-to-everything (CV2X) communications in communication systems. Changes may be made in the function and arrangement of elements discussed without departing from the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth, millimeter wave mmW, massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QOS) requirements. In addition, these services may co-exist in the same subframe.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHZ). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

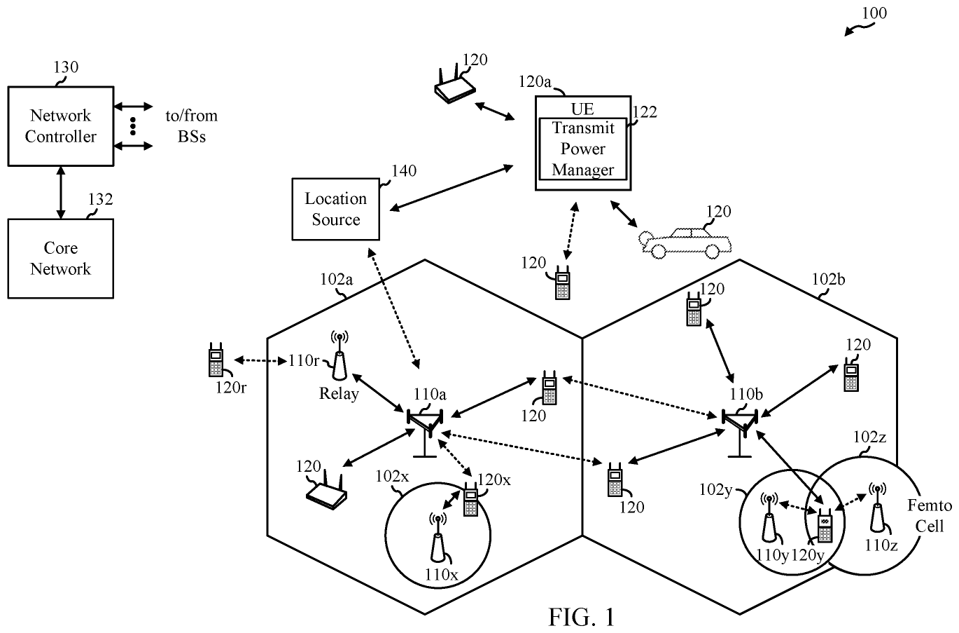

FIG. 1 illustrates an example wireless communication network 100 in which aspects of the present disclosure may be performed. For example, the wireless communication network 100 may be an NR system (e.g., a 5G NR network). As shown in FIG. 1, the wireless communication network 100 may be in communication with a core network 132. The core network 132 may be in communication with one or more base station (BSs) 110a-z (each also individually referred to herein as BS 110 or collectively as BSs 110) and/or user equipment (UE) 120a-y (each also individually referred to herein as UE 120 or collectively as UEs 120) in the wireless communication network 100 via one or more interfaces.

As shown in FIG. 1, the UE 120a includes a transmit power manager 122 that identifies its location from a location source 140 (e.g., a global navigation satellite system, a wireless local area network, a roadside unit, and/or another UE) and determines a transmit power based at least in part on an additional maximum power reduction value associated with the region, in accordance with aspects of the present disclosure.

In this example, the UE 120a may be in communication with other UEs 120 without an operator controlled cellular network, such as the network formed with BSs 110a and 110b. For example, the UE 120a may be in communication with the other UEs 120 via sidelink communications. In certain cases, the UE 120a may communicate directly with the other UEs 120 via the sidelink communications.

A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a and 110b may be macro BSs for the macro cells 102a, 102b, respectively. The BS 110x may be a pico BS for a pico cell 102x. The BSs 110y and 110z may be femto BSs for the femto cells 102y and 102z, respectively. A BS may support one or multiple cells.

The BSs 110 communicate with UEs 120 in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may be in communication with a set of BSs 110 and provide coordination and control for these BSs 110 (e.g., via a backhaul). In certain cases, the network controller 130 may include a centralized unit (CU) and/or a distributed unit (DU), for example, in a 5G NR system. In aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

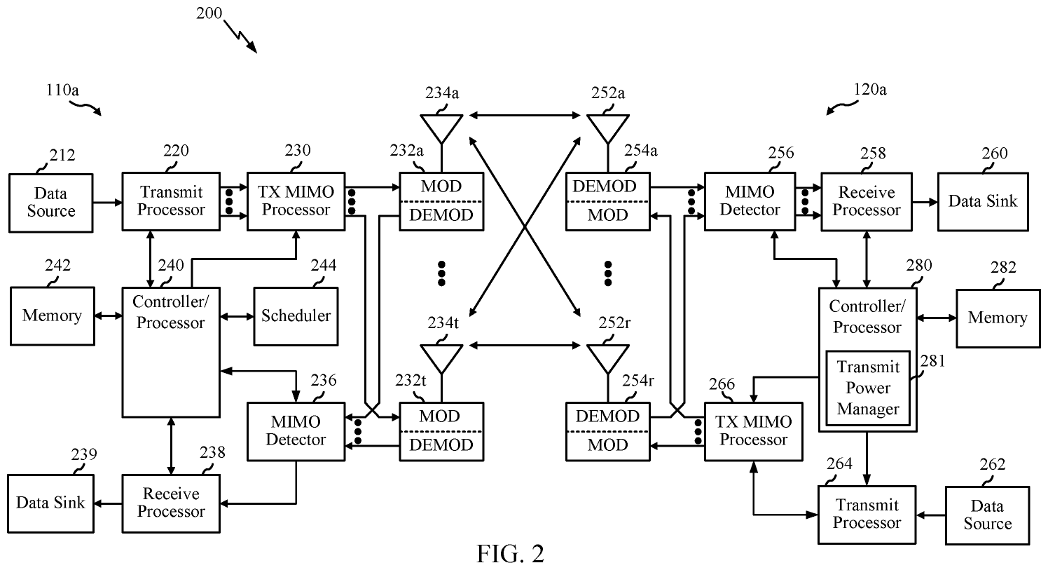

FIG. 2 illustrates example components of BS 110a and UE 120a (e.g., the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM, etc.), and transmitted to the BS 110a. At the BS 110a, the uplink signals from the UE 120a may be received by the antennas 234, processed by the demodulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. For example, as shown in FIG. 2, the controller/processor 280 of the UE 120a has a transmit power manager 281 that may be representative of the transmit power manager 122, according to aspects described herein. Although shown at the controller/processor, other components of the UE 120a and BS 110a may be used to perform the operations described herein.

While the UE 120a is described with respect to FIGS. 1 and 2 as communicating with a BS and/or within a network, the UE 120a may be configured to communicate directly with/transmit directly to another UE 120, or with/to another wireless device without relaying communications through a network. In certain aspects, the BS 110a illustrated in FIG. 2 and described above is an example of another UE 120.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

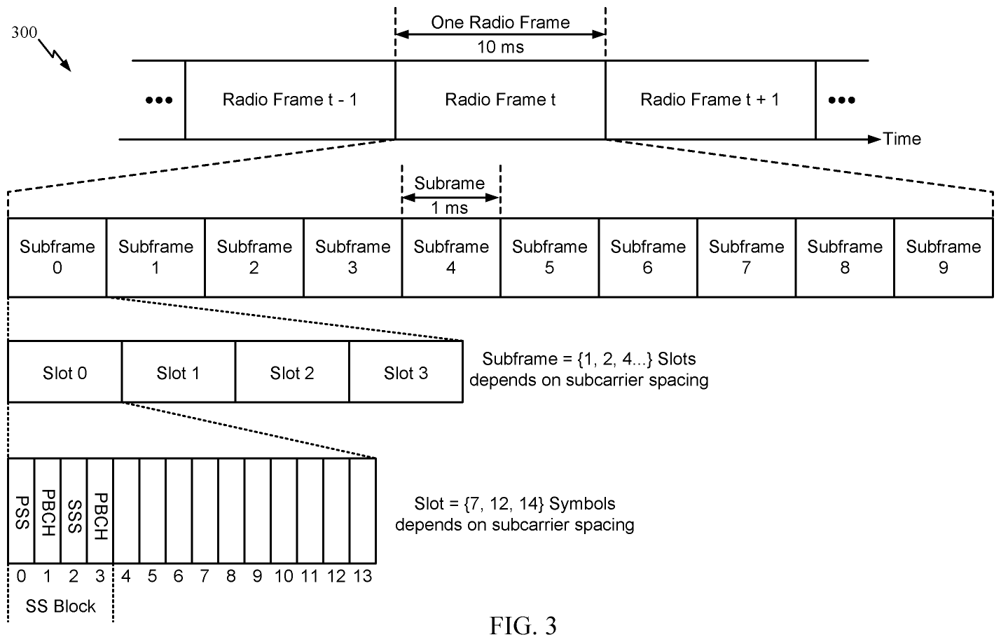

FIG. 3 is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots (e.g., 1, 2, 4, 8, 16, . . . slots) depending on the SCS. Each slot may include a variable number of symbol periods (e.g., 7, 12, or 14 symbols) depending on the SCS. The symbol periods in each slot may be assigned indices. A sub-slot structure may refer to a transmit time interval having a duration less than a slot (e.g., 2, 3, or 4 symbols). Each symbol in a slot may be configured for a link direction (e.g., downlink (DL), uplink (UL), or flexible) for data transmission and the link direction for each subframe may be dynamically switched. The link directions may be based on the slot format. Each slot may include DL/UL data as well as DL/UL control information.

In NR, a synchronization signal block (SSB) is transmitted. In certain aspects, SSBs may be transmitted in a burst where each SSB in the burst corresponds to a different beam direction for UE-side beam management (e.g., including beam selection and/or beam refinement). The SSB includes a PSS, a SSS, and a two symbol PBCH. The SSB can be transmitted in a fixed slot location, such as the symbols 0-3 as shown in FIG. 3. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst periodicity, system frame number, etc. The SSBs may be organized into an SS burst to support beam sweeping. Further system information such as, remaining minimum system information (RMSI), system information blocks (SIBs), other system information (OSI) can be transmitted on a physical downlink shared channel (PDSCH) in certain subframes. The SSB can be transmitted up to sixty-four times within an SS burst, for example, with up to sixty-four different beam directions for mmWave. The multiple transmissions of the SSB are referred to as an SS burst in a half radio frame. SSBs in an SS burst may be transmitted in the same frequency region, while SSBs in different SS bursts can be transmitted at different frequency regions.

### Example Sidelink Communications

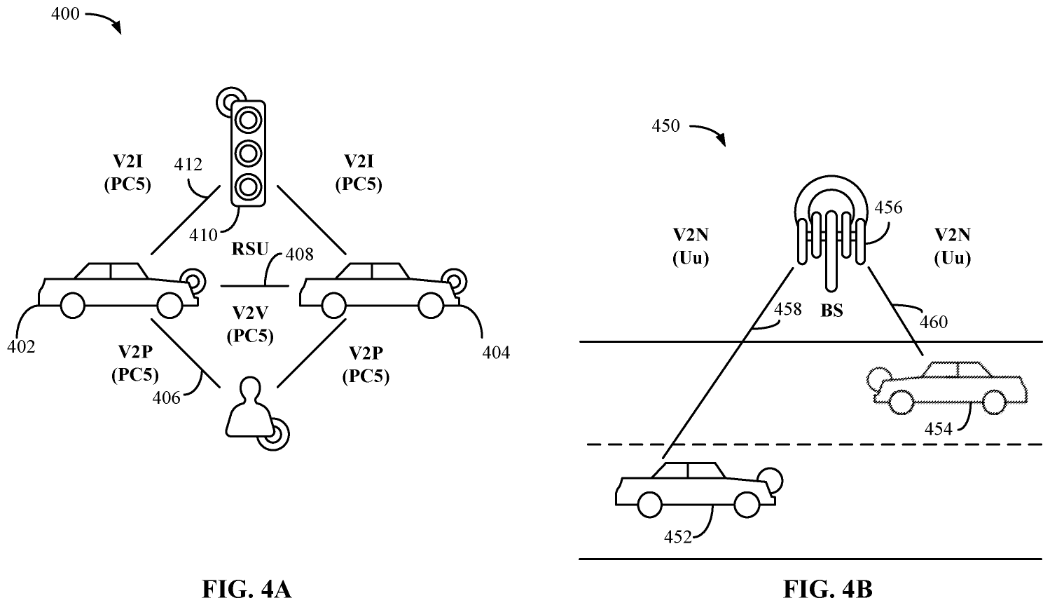

FIG. 4A and FIG. 4B show diagrammatic representations of example V2X systems, in accordance with some aspects of the present disclosure. For example, the vehicles shown in FIG. 4A and FIG. 4B may communicate via sidelink channels and may relay sidelink transmissions as described herein. The V2X systems, may be examples of sidelink communication systems discussed herein, and the vehicles and other devices may be configured to communicate over sidelink frequency channels as discussed herein.

The V2X systems provided in FIG. 4A and FIG. 4B provide two complementary transmission modes. A first transmission mode (also referred to as mode 4), shown by way of example in FIG. 4A, involves direct communications (for example, also referred to as sidelink communications) between participants in proximity to one another in a local area. A second transmission mode (also referred to as mode 3), shown by way of example in FIG. 4B, involves network communications through a network, which may be implemented over a Uu interface (for example, a wireless communication interface between a radio access network (RAN) and a UE).

Referring to FIG. 4A, a V2X system 400 (for example, including vehicle-to-vehicle (V2V) communications) is illustrated with two vehicles 402, 404. The first transmission mode allows for direct communication between different participants in a given geographic location. As illustrated, a vehicle can have a wireless communication link 406 with an individual (V2P) (for example, via a UE) through a PC5 interface. Communications between the vehicles 402 and 404 may also occur through a PC5 interface 408. In a like manner, communication may occur from a vehicle 402 to other highway components (for example, highway component 410), such as a traffic signal or sign (V2I) through a PC5 interface 412. With respect to each communication link illustrated in FIG. 4A, two-way communication may take place between elements, therefore each element may be a transmitter and a receiver of information. The V2X system 400 may be a self-managed system implemented without assistance from a network entity. A self-managed system may enable improved spectral efficiency, reduced cost, and increased reliability as network service interruptions do not occur during handover operations for moving vehicles. The V2X system may be configured to operate in a licensed or unlicensed spectrum, thus any vehicle with an equipped system may access a common frequency and share information. Such harmonized/common spectrum operations allow for safe and reliable operation.

FIG. 4B shows a V2X system 450 for communication between a vehicle 452 and a vehicle 454 through a network entity 456. These network communications may occur through discrete nodes, such as a BS (e.g., the BS 110a), that sends and receives information to and from (for example, relays information between) vehicles 452, 454. The network communications through vehicle to network (V2N) links 458 and 460 may be used, for example, for long-range communications between vehicles, such as for communicating the presence of a car accident a distance ahead along a road or highway. Other types of communications may be sent by the wireless node to vehicles, such as traffic flow conditions, road hazard warnings, environmental/weather reports, and service station availability, among other examples. Such data can be obtained from cloud-based sharing services.

Roadside units (RSUs) may be utilized. An RSU may be used for V2I communications. In some examples, an RSU may act as a forwarding node to extend coverage for a UE. In some examples, an RSU may be co-located with a BS or may be standalone. RSUs can have different classifications. For example, RSUs can be classified into UE-type RSUs and Micro NodeB-type RSUs. Micro NodeB-type RSUs have similar functionality as a Macro eNB or gNB. The Micro NodeB-type RSUs can utilize the Uu interface. UE-type RSUs can be used for meeting tight quality-of-service (Qos) requirements by minimizing collisions and improving reliability. UE-type RSUs may use centralized resource allocation mechanisms to allow for efficient resource utilization. Critical information (e.g., such as traffic conditions, weather conditions, congestion statistics, sensor data, etc.) can be broadcast to UEs in the coverage area. Relays can re-broadcasts critical information received from some UEs. UE-type RSUs may be a reliable synchronization source.

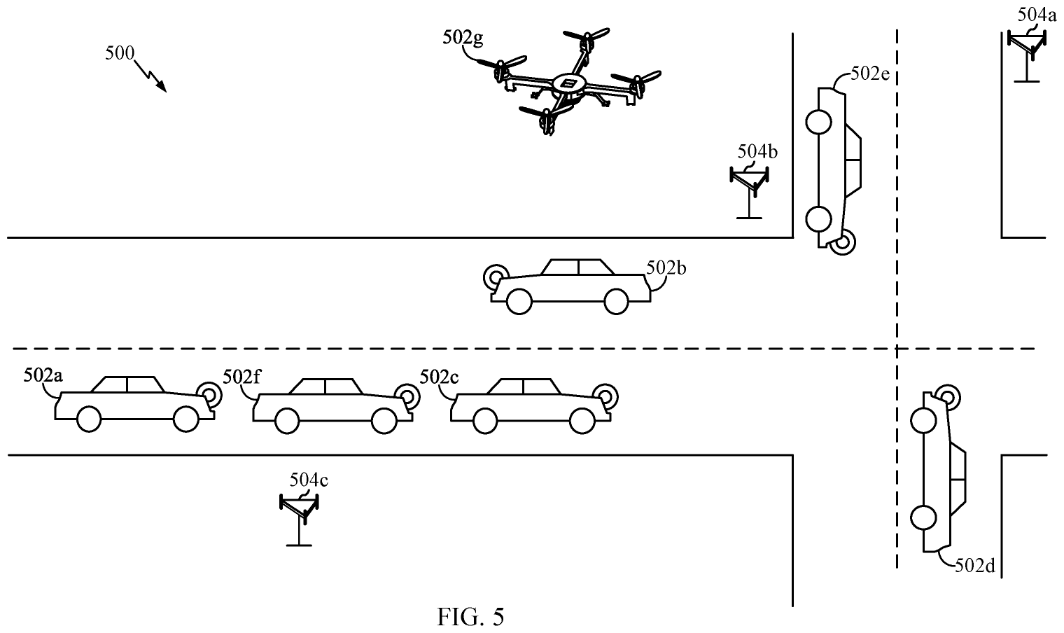

FIG. 5 is a schematic diagram illustrating an example network 500 of multiple CV2X devices operating in an unlicensed spectrum. The unlicensed spectrum may be an example of a sidelink frequency band. Further, the network 500 may be an example of a sidelink communication system. The CV2X devices 502 may be configured to communicate on sidelink frequency channels as discussed herein. For example, any of the CV2X devices 502 may communicate with any other of the CV2X devices 502.

In the illustrated example, seven CV2X devices (e.g., a first CV2X device 502a, a second CV2X device 502b, a third CV2X device 502c, a fourth CV2X device 502d, a fifth CV2X device 502e, a sixth CV2X device 502f, and a seventh CV2X device 502g)-collectively referred to as CV2X devices 502) may operate in an unlicensed spectrum with other non-CV2X devices (e.g., non-CV2X devices 504a-c-collectively referred to as non-CV2X devices 504). In some examples, the first CV2X device 502a, the sixth CV2X device 502f, and the third CV2X device 502c may be part of a fleet or platoon. In transportation, platooning or flocking is a method for driving a group of vehicles together. It is meant to increase the capacity of roads via an automated highway system. Platoons decrease the distances between cars or trucks, such as based on SL communications.

Although the example provided is illustrative of six automotive CV2X devices in a traffic setting and a drone or other aerial vehicle CV2X device, it can be appreciated that CV2X devices and environments may extend beyond these, and include other wireless communication devices and environments. For example, the CV2X devices 502 may include UEs (e.g., UE 120 of FIG. 1) and/or roadside units (RSUs) operated by a highway authority, and may be devices implemented on motorcycles or carried by users (e.g., pedestrian, bicyclist, etc.), or may be implemented on another aerial vehicle such as a helicopter.

The CV2X devices 502 may include UEs (e.g., UE 120 of FIG. 1), and may be devices implemented on motorized vehicles or carried by users (e.g., pedestrian, bicyclist, etc.), or implemented as a roadside unit.

### Example RF Transceiver

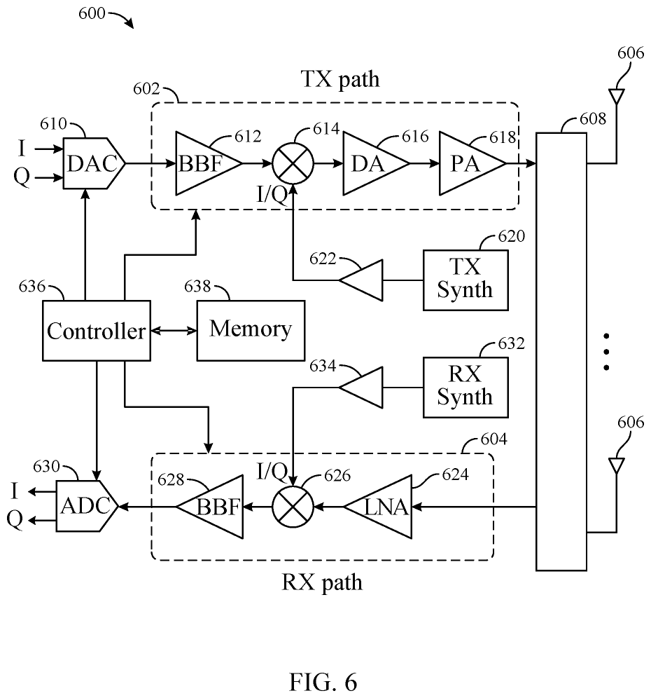

FIG. 6 is a block diagram of an example radio frequency (RF) transceiver circuit 600, in accordance with certain aspects of the present disclosure. The RF transceiver circuit 600 includes at least one transmit (TX) path 602 (also known as a transmit chain) for transmitting signals via one or more antennas 606 and at least one receive (RX) path 604 (also known as a receive chain) for receiving signals via the antennas 606. When the TX path 602 and the RX path 604 share an antenna 606, the paths may be connected with the antenna via an interface 608, which may include any of various suitable RF devices, such as a switch, a duplexer, a diplexer, a multiplexer, and the like.

Receiving in-phase (I) or quadrature (Q) baseband analog signals from a digital-to-analog converter (DAC) 610, the TX path 602 may include a baseband filter (BBF) 612, a mixer 614, a driver amplifier (DA) 616, and a power amplifier (PA) 618. The BBF 612, the mixer 614, and the DA 616 may be included in one or more radio frequency integrated circuits (RFICs). The PA 618 may be external to the RFIC(s) for some implementations.

The BBF 612 filters the baseband signals received from the DAC 610, and the mixer 614 mixes the filtered baseband signals with a transmit local oscillator (LO) signal to convert the baseband signal of interest to a different frequency (e.g., upconvert from baseband to a radio frequency). This frequency conversion process produces the sum and difference frequencies between the LO frequency and the frequencies of the baseband signal of interest. The sum and difference frequencies are referred to as the beat frequencies. The beat frequencies are typically in the RF range, such that the signals output by the mixer 614 are typically RF signals, which may be amplified by the DA 616 and/or by the PA 618 before transmission by the antenna 606. While one mixer 614 is illustrated, several mixers may be used to upconvert the filtered baseband signals to one or more intermediate frequencies and to thereafter upconvert the intermediate frequency signals to a frequency for transmission.

The RX path 604 may include a low noise amplifier (LNA) 624, a mixer 626, and a baseband filter (BBF) 628. The LNA 624, the mixer 626, and the BBF 628 may be included in one or more RFICs, which may or may not be the same RFIC that includes the TX path components. RF signals received via the antenna 606 may be amplified by the LNA 624, and the mixer 626 mixes the amplified RF signals with a receive local oscillator (LO) signal to convert the RF signal of interest to a different baseband frequency (e.g., downconvert). The baseband signals output by the mixer 626 may be filtered by the BBF 628 before being converted by an analog-to-digital converter (ADC) 630 to digital I or Q signals for digital signal processing.

Some systems may employ frequency synthesizers with a voltage-controlled oscillator (VCO) to generate a stable, tunable LO with a particular tuning range. Thus, the transmit LO may be produced by a TX frequency synthesizer 620, which may be buffered or amplified by amplifier 622 before being mixed with the baseband signals in the mixer 614. Similarly, the receive LO may be produced by an RX frequency synthesizer 632, which may be buffered or amplified by amplifier 634 before being mixed with the RF signals in the mixer 626.

A controller 636 may direct the operation of the RF transceiver circuit 600, such as transmitting signals via the TX path 602 and/or receiving signals via the RX path 604. The controller 636 may be a processor, a digital signal processor (DSP), an application specific integrated circuit (ASIC), a field programmable gate array (FPGA) or other programmable logic device (PLD), discrete gate or transistor logic, discrete hardware components, or any combination thereof. The memory 638 may store data and program codes for operating the RF transceiver circuit 600. In certain cases, the controller 636 may determine a transmit power to generate with the TX path 602 for a transmission signal where the transmit power complies with an RF emission requirement (e.g., a maximum output power) set by domestic/foreign regulations and/or international standards as further described herein. For example, the controller 636 may adjust the gain applied at the PA 618 to produce the transmit power in compliance with the RF emission requirement.

### Example Transmit Power Requirements

In certain wireless communication systems (e.g., Evolved Universal Terrestrial Radio Access (E-UTRA) and/or 5G NR), there are RF emission requirements for the output power of UEs. The UE may set its configured maximum output power based on various parameters, such as a maximum power reduction (MPR) and/or an additional MPR (A-MPR). The maximum UE power may be a value specified by UE power class and/or frequency band. As an example for a V2X UE in an E-UTRA system, the UE may set its configured maximum output power P_{CMAX,c} for a given cell with the following bounds:

$${P}_{CMAX\_L , c} \leq {P}_{CMAX , c} \leq {P}_{CMAX\_H , c} with {P}_{CMAX\_L , c} = MIN \{ {P}_{EMAX , c} - Δ {T}_{C , c} , {P}_{PowerClass} - MAX ( {MPR}_{c} + A ‐ {MRP}_{c} + Δ {T}_{IB , c} + {ΔT}_{C , c} + {ΔT}_{ProSe} , P ‐ {MPR}_{c} ) , {P}_{Regulatory , c} \} {P}_{CMAX\_H , c} = MIN \{ {P}_{EMAX , c} , {P}_{PowerClass} , {P}_{Regulatory , c} \} \qquad ( 1 )$$

where:
P_{EMAX,c} is a value given by network, for example, via system information;
P_{PowerClass} is the maximum UE power specified for each frequency band without taking into account the tolerance specified (e.g., 23 dBm);
MPR_{c} for the serving cell c may be a preconfigured value or given by the network, for example, via system information;
A-MPR_{c} for the serving cell c may be given by the network via system information;
ΔT_{IB,c} is the additional tolerance for serving cell c when inter-band carrier aggregation is configured; ΔT_{IB,c}=0 dB otherwise;
ΔT_{C,c}=1.5 dB when certain conditions apply;
ΔT_{C,c}=0 dB when the certain conditions do not apply;
ΔT_{ProSe}=0.1 dB when the UE supports ProSe Direct Discovery and/or ProSe Direct Communication on the corresponding E-UTRA ProSe band; ΔT_{ProSe}=0 dB otherwise; and

P_{Regulatory,c}=10−G_{post connector} dBm when the V2X UE is within the protected zone of CEN DSRC tolling system and operating in Band 47; P_{Regulatory,c}=33−G_{post connector} dBm otherwise. While the above expression is described herein with respect to P_{CMAX,c} for V2X in an E-UTRA system to facilitate understanding, aspects of the present disclosure may also be applied to a separate expression and/or parameters used for 5G NR systems. In certain cases (e.g., for certain V2X applications), the applied maximum power reduction may be obtained by taking the maximum between MPR and A-MPR (e.g., max {MPR, A-MPR}).

In certain cases, the MPR may vary due to order modulation and/or transmit bandwidth as provided in Table 1 below.

TABLE 1

| | | Channel bandwidth / Transmission bandwidth (N_{RB}) | | | | | | |
|---|---|---|---|---|---|---|---|---|
| | | 1.4 | 3.0 | 5 | 10 | 15 | 20 | MPR |
| Modulation | | MHz | MHz | MHz | MHz | MHz | MHz | (dB) |
| QPSK | | >5 | >4 | >8 | >12 | >16 | >18 | ≤1 |
| 16 | QAM | ≤5 | ≤4 | ≤8 | ≤12 | ≤16 | ≤18 | ≤1 |
| 16 | QAM | >5 | >4 | >8 | >12 | >16 | >18 | ≤2 |
| 64 | QAM | ≤5 | ≤4 | ≤8 | ≤12 | ≤16 | ≤18 | ≤2 |
| 64 | QAM | >5 | >4 | >8 | >12 | >16 | >18 | ≤3 |

| | | | |
|---|---|---|---|
| 256 | QAM | ≥1 | ≤5 |

The A-MPR may provide a dynamic reduction factor. For example, the A-MPR may vary due to the region in which the UE is located and may be configured at the UE by the network, for example, via system information. The network may use network signaling values or codepoints associated with a specific A-MPR (or A-MPR base value and/or step) to indicate the A-MPR to use. Various countries and/or regions may have different power limit standards for CV2X. For example, the requirements of CV2X A-MPR for a network signaling value of NS_33 in E-UTRA systems are shown in Table 2 below for, where A-MPR_{Base} is the default A-MPR value when no G_{post connector} is declared, and the A-MPRₛₜₑₚ is the increase in A-MPR allowance to allow the UE to meet tighter conducted spectrum emission requirements with higher value of declared G_{post connector}.

TABLE 2

| | Carrier | Resources | Start | | |
|---|---|---|---|---|---|
| Resource | frequency | Blocks | Resource | | |
| pool | (MHz) | (N_{RB}) | Block | A-MPR_{Base} | A-MPR_{Step} |
| Adjacent | 5860 | ≤6 | 0 | 20 | 0.86 |
| | | | 5, 6 | 8 | 0.64 |
| | | | 10, 12 | 6 | 0.50 |
| | | | ≥15 | 5 | 0.93 |
| | | >6 and ≤10 | 0 | 15.5 | 0.86 |
| | | | 5, 6 | 8 | 0.64 |
| | | | 10, 12 | 6 | 0.50 |
| | | | ≥15 | 5 | 0.93 |
| | | >10 and ≤22 | 0 | 15 | 0.71 |
| | | | 5, 6 | 11.5 | 0.64 |
| | | | 10, 12 | 10 | 0.57 |
| | | | 15, 18 | 6 | 0.57 |
| | | | 20, 24, 25 | 5 | 0.57 |
| | | | ≥30 | 4.5 | 0.64 |
| | | >22 | 0, 5, 6 | 12.5 | 0.71 |
| | | | 10, 12 | 10.5 | 0.57 |
| | | | 15, 18 | 9.5 | 0.64 |
| | | | 20, 24, 25 | 6.5 | 0.71 |
| | 5870, | <20 | ≥0 | 3 | 0.64 |
| | 5910, 5920 | ≥20 and ≤45 | | 1.5 | 0.43 |
| | | >45 | | 2.5 | 0.36 |
| | 5880, | <10 | ≥0 | 3 | 0.43 |
| | 5890, 5900 | ≥10 and ≤38 | | 1.5 | 0.50 |
| | | >38 | | 2 | 0.43 |
| Non- | 5860 | ≤5 | ≥0 | 13.5 | 1 |
| Adjacent | | >5 | | 11.5 | 1 |
| | 5870, | ≤5 | ≥0 | 5 | 1 |
| | 5910, 5920 | >5 and ≤42 | | 3 | 1 |
| | | >42 | | 4.5 | 1 |
| | 5880, | ≤18 | ≥0 | 3.5 | 1 |
| | 5890, 5900 | >18 and ≤42 | | 2.5 | 1 |
| | | >42 | | 3 | 1 |

Certain organizations and regulatory bodies (such as the Federal Communications Commission (FCC) for the United States; Innovation, Science and Economic Development Canada (ISED) for Canada; or International Commission on Non-Ionizing Radiation Protection (ICNIRP) standard followed by the European Union (EU)) may provide specific A-MPR values for CV2X. A specific regulatory body may require extra power backoff (e.g., a specific value of A-MPR) according to the modulation order in addition to bandwidth and carrier frequency.

In certain cases, CV2X systems may have no radio access network to indicate the appropriate A-MPR value. In other words, a CV2X system may be made of entirely other CV2X UEs without any network entities such as a base station or network controller to provide the A-MPR value applicable to the region where the CV2X UE is located. In such cases, a CV2X UE may not be aware of the power limitation standard (e.g., the A-MPR) applicable to the region in which the CV2X UE is located due to the absence of control signaling (e.g., system information) from the network. Accordingly, what is needed are techniques and apparatus for identifying the transmit power backoff for CV2X applications.

### Example Geography Based Transmit Power Backoff in a CV2X System

Aspects of the present disclosure provide techniques and apparatus for identifying the transmit power backoff in a CV2X system based on the geographic location of the CV2X UE. For example, the UE may identify a geographic region (e.g., the United State, China, the European Union) in which the UE is located, and the UE may select an A-MPR value associated with the region, for example, from a list of regions with corresponding A-MPR values. With the selected A-MPR, the UE may determine a maximum transmit power, for example, within the bounds of Expression (1), where P_{CMAX_L,c} may be calculated using the A-MPR value. The UE may determine a transmit power in compliance with the configured maximum output power (e.g., P_{CMAX,c}) and/or other emission requirements, such as RF exposure limits.

As an example, when a UE is turned on, the modem may query geographic location information from an application processor. During a transmission, a protocol stack may provide an RF transceiver with corresponding network signaling value (e.g., NS_33 or NS_34) associated with the geographic information. The RF transceiver may compute the maximum output power using the A-MPR associated with the networking signaling value. With an internally generated networking signaling value, the UE can update the network signaling value in real time if the UE moves to a different region with different RF emission requirements, such as a different A-MPR.

The techniques and apparatus for identifying the transmit power backoff described herein may enable a CV2X UE to be in compliance with regulatory standards of a given region, for example, due to the identification of the A-MPR value specified in the region. The techniques and apparatus for identifying the transmit power backoff described herein may enable a CV2X UE to have desirable performance (e.g., desirable data rates, latencies, and/or signal quality) in compliance with the transmit power standards for a given region, for example, due to the identification of the A-MPR value (which may vary across regions) specific to the region.

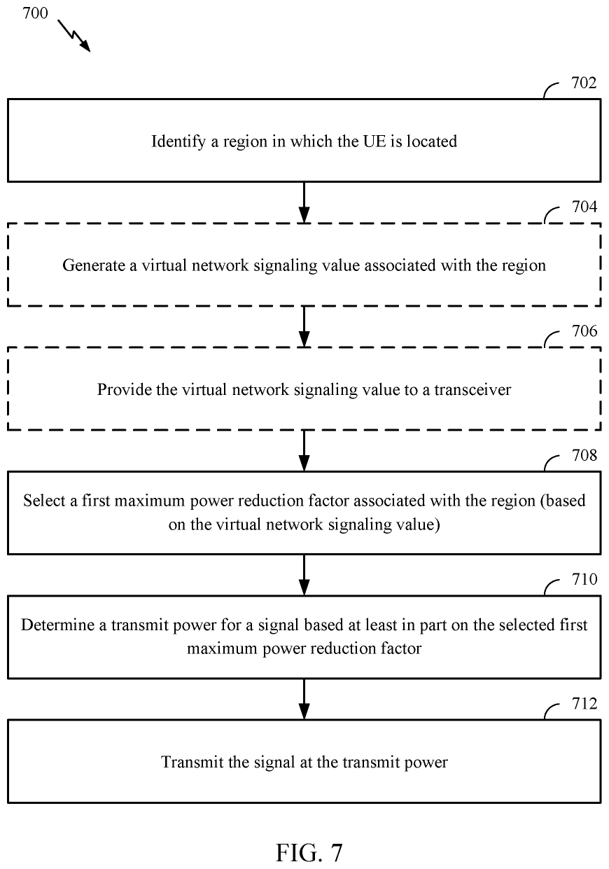

FIG. 7 is a flow diagram illustrating example operations 700 for wireless communication, in accordance with certain aspects of the present disclosure. The operations 700 may be performed, for example, by a UE (such as the UE 120a in the wireless communication network 100). The operations 700 may be implemented as software components that are executed and run on one or more processors (e.g., controller/processor 280 of FIG. 2). Further, the transmission and reception of signals by the UE in operations 700 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 700 may begin, at block 702, where the UE may identify a region in which the UE is located. The UE may identify the region in which the UE is located using geospatial information obtained from a global navigation satellite system, such as Global Positioning System (GPS), GLObal NAvigation Satellite System (GLONASS), or Galileo. For example, the UE may obtain its location in terms of geographic coordinates derived from the global navigation satellite system and correlate the geographic coordinates to the region, which may have specific value(s) for the A-MPR. In certain cases, the UE may identify the region in which the UE is located using wireless local area network (WLAN) positioning system. For example, the UE may use characteristics (e.g., service set identifier (SSID) and media access control (MAC) address) of nearby WLAN access points to determine where the UE is located, and the UE may map its location to the region. As used herein, a region may refer to a geographical area such as the borders of a country (e.g., the United States or China) or a collection of countries (e.g., the European Union). In aspects, the region may be a geographic area associated with at least a portion of a public land mobile network (PLMN) that uses a specific A-MPR for its network.

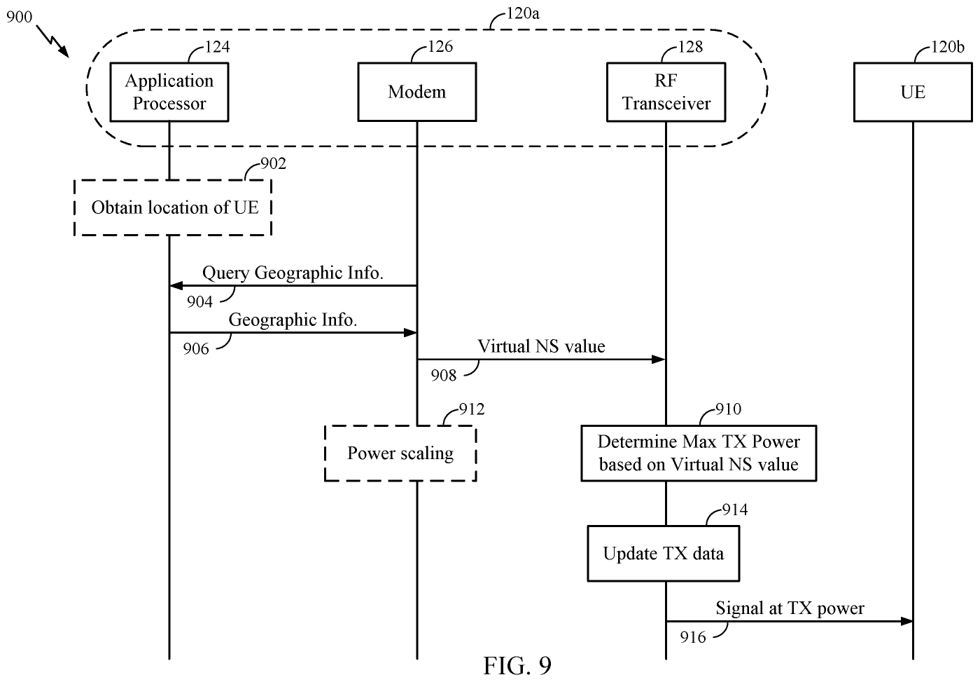

Optionally, at block 704, the UE may generate a virtual network signaling value associated with the region. For example, the UE may identify a network signaling value (e.g., NS_33 or NS_34 for CV2X in a E-UTRA system or NS_01, NS_33, or NS_52 for CV2X in 5G NR systems) associated with the region and generate the virtual network signaling value, where the network signaling value may be associated with a specific A-MPR value. That is, a specific region may have one or more network signaling values associated with that region, and the UE may map the region in which it is located to the network signaling value(s). The virtual networking signaling value may be a fake or dummy value generated internally at the UE without any signaling from a wireless communications network, such as public land mobile network (PLMN). The virtual network signaling value may be used to spoof a transceiver at the UE into considering the virtual network signaling value to be the real value for the region. In certain cases, the UE may generate the virtual network signaling value with a modem and/or controller, for example, as further described herein with respect to FIG. 9. The UE may have a look-up table that maps regions to specific networking signaling values and/or A-MPR.

Optionally, at block 706, the UE may provide the virtual network signaling value to a transceiver (e.g., the transceiver 254). For example, the modem or controller of the UE may call the transceiver's application programming interface (API) via a protocol stack to provide the virtual network signaling value. In certain cases, the modem or controller may call the transceiver API periodically (e.g., every radio frame) to provide the virtual network signaling value associated with the region in which the UE is located.

At block 708, the UE may select a first maximum power reduction (MPR) value (e.g., an A-MPR having a value of 6-14 dB depending on the bandwidth, subcarrier spacing, and/or modulation order) associated with the region. The first MPR value may include a region specific value for an A-MPR. In general, the first MPR value may be referred to as the A-MPR or A-MPR value with respect to the operations 700. In certain cases, the UE may select the A-MPR based on the region identified at block 702. For example, the UE may map the region to a specific A-MPR using a list of A-MPRs associated with specific regions. In certain cases, the selection of the A-MPR value may be based on the virtual network signaling value. For example, the transceiver of the UE may determine the A-MPR value based on the virtual network signaling value provided at block 706.

At block 710, the UE may determine a transmit power for a signal based at least in part on the selected A-MPR value. For example, the UE may determine the maximum output power (e.g., PCMAX) allowed for a transmission based at least in part on the A-MPR value, for example, using Expression (1) and/or a similar expression for 5G NR systems. While determining the transmit power, the UE may determine the transmit power to be in compliance with the maximum output power calculated based at least in part on the A-MPR. For example, the UE may select a transmit power to be less than or equal to the maximum output power (e.g., PCMAX). For certain cases, the UE may identify that the A-MPR value for the region and/or other criteria is zero, such that the A-MPR does not affect the determination of the transmit power at block 710.

At block 712, the UE may transmit the signal at the transmit power. For example, the UE may transmit autonomous driving information (e.g., an indication of a vehicle's intended path, sensor data, situational awareness such as warnings of traffic changes) to another CV2X device at the determined transmit power. In certain cases, the UE may transmit the signal to another UE using C-V2X communications, for example, according to the standards for E-UTRA and/or 5G NR systems.

In aspects, the UE may determine the transmit power based on a maximum output power with lower and upper bounds, for example, as described herein with respect to Expression (1). In certain cases, the determination of the transmit power may include the UE determining a low value (e.g., a lower bound) for a maximum output power based at least in part on a second MPR value (e.g., an MPR value) and the first MPR value (e.g., the A-MPR value). The second MPR value may include a particular value for an MPR, which may be separate from an A-MPR. The second MPR value may be generally referred to as the MPR or the MPR value with respect to the operations 700. For example, the UE may determine the value of P_{CMAX_L,c} in Expression (1) where the maximum output power of a power class (e.g., P_{PowerClass}) subtracted by a sum including the MPR and A-MPR (e.g., the sum: MPR_{c}+A-MPR_{c}+ΔT_{IB,c}+ΔT_{C,c}+ΔT_{ProSe}) may satisfy the minimum condition MIN { . . . }. The UE may also determine a high value (e.g., an upper bound) for the maximum output power. For example, the UE may determine the value of P_{CMAX_H,c} in Expression (1) where the UE may select the minimum among P_{EMAX,c}, P_{PowerClass}, and P_{Regulatory,c} as the high value for the maximum output power. The UE may select the maximum output power within the low value and the high value (e.g., P_{CMAX_L,c}≤P_{CMAX,c}≤P_{CMAX_H,c}). In certain cases (e.g., for certain V2X applications), the applied maximum power reduction may be obtained by taking the maximum between MPR and A-MPR (e.g., max {MPR, A-MPR}). The UE may determine the transmit power based at least in part on the selected maximum output power. As an example, the UE may determine the transmit power to be less than or equal to the selected maximum output power.

For certain aspects, the A-MPR value may include various reduction factors for determining a maximum output transmit power. For example, the A-MPR value may include a value associated with a network signaling value (e.g., NS_33 or NS_34) and a region specific value. The value associated with a networking signaling value may include one or more parameters used to calculate the A-MPR, such as the A-MPR base value and A-MPR step. In certain cases, the region specific value may be an extra output power backoff according to a modulation order, bandwidth, subcarrier spacing, and/or carrier frequency.

The UE may identify the region using various positional information. In certain cases, the identification of the region may be performed using characteristics of a WLAN or other wireless communications networks. For example, the UE may receive, from an access point, a signature associated with the access point. The signature may include the SSID and/or MAC address of the access point. The UE may map the signature to a particular location or sub-region of the access point, for example, using a database of unique wireless networks (e.g., WLANs) mapped to geo-positioning coordinates (e.g., an SSID and MAC address of an access point associated with a latitude and longitude). The UE may identify the region based at least in part on the location of the access point. For example, the UE may assume the location of the access point is the UE's location and identify the region in which that location resides. That is, the UE may receive an indication of its location from the access point. In certain cases, the access point may be a network entity in a WLAN. That is, the UE may receive the signature from the access point via a WLAN.

For certain cases, the identification of the region may be performed using a global navigation satellite system. The UE may receive signals from a global navigation satellite system (e.g., GPS, GLONASS, or Galileo) and identify a location of the UE based on the received signals. For example, the UE may derive its location based on the time delays between when the satellite transmit the signal and the UE receives the signal. The UE may determine pseudo-ranges between multiple satellites and the UE based on the time delays and the speed of light. The UE may identify the region based on the location of the UE. That is, the UE may identify the region in which the UE's location resides.

In certain cases, the identification of the region may be performed using other sources of location information, such as an RSU and/or another CV2X device. For example, the UE may receive, from an RSU, an identifier associated with the RSU, and the UE may map the RSU's identifier to a location of the RSU. The UE may assume the RSU's location is the UE's location and identify the region in which that location resides. The UE may obtain location information from to another CV2X device. For example, the other CV2X may share its location with the UE or other information that can be used to derive the location of the UE, such as characteristic(s) of a WLAN and/or PLMN (e.g., a mobile country code) to which the other CV2X device is connected.

In certain aspects, the UE may use the location information from the various location sources separately or in a combination to identify the region in which the UE is located. For example, the UE may derive its location from a global navigation satellite system and a WLAN. In some cases, the UE may derive its location using only a single location source, such as a global navigation satellite system.

For certain aspects, the UE may update the A-MPR value in response to a change in location of the UE and/or other criteria. The UE may periodically monitor its location using the various positional information described herein. In response to any change in its location, the UE may update the A-MPR value to a value associated with the location of the UE. The UE may determine another transmit power for another signal based at least in part on the updated A-MPR value, and the UE may transmit the other signal at the other transmit power. For example, the UE may determine the maximum output power based at least in part on the updated A-MPR value as described herein with respect to Expression (1), and the UE may select the other transmit power to be less than or equal to the maximum output power. Such a response to a change in location may enable to the UE to adapt to the varying A-MPR values across different regions such as Europe, China, or the United States.

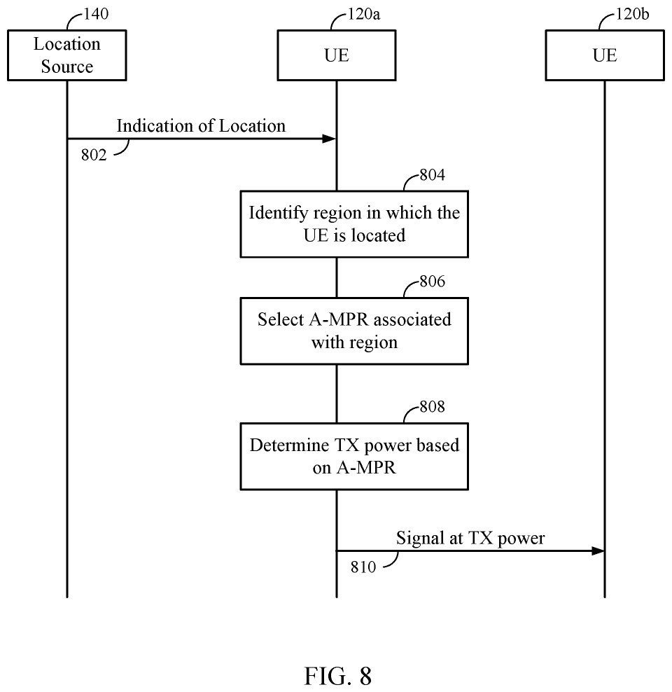

FIG. 8 is a signaling diagram illustrating example signaling of identifying a geography-based transmit power backoff, in accordance with certain aspects of the present disclosure. At 802, a first UE 120a may receive an indication of its location from a location source 140, such as a network entity in a WLAN, a global navigation satellite system, an RSU, and/or another UE (e.g., the second UE 120b). As an example, the first UE 120a may receive signals from a global navigation satellite system that provide the first UE 120a with an indication of its geographic location (e.g., geographic coordinates in terms of longitude and latitude). At 804, the first UE 120a may identify the region in which the first UE 120a is located, and at 806, the first UE 120a may select an A-MPR associated with the region. In certain cases, the first UE 120a may select parameters (A-MPR base and/or A-MPR step value(s)) associated with the region that allow the first UE 120a to calculate the A-MPR. Multiple A-MPRs may be associated with the region, and the first UE 120a may select a specific A-MPR based on one or more transmission criteria, such as the carrier frequency, bandwidth, subcarrier spacing, and/or modulation order for a transmission. At 808, the first UE 120a may determine the transmit power for a signal based on the selected A-MPR, for example, according to Expression (1) or a similar expression for 5G NR systems. At 810, the first UE 120a may transmit a signal at the transmit power to the second UE 120b, where both UEs may be CV2X devices.

FIG. 9 is a signaling diagram illustrating an example of internal signaling of identifying a geography-based transmit power backoff, in accordance with certain aspects of the present disclosure. At 902, an application processor 124 of the first UE 120a may obtain the location of the UE, for example, via a WLAN, a global navigation satellite system, an RSU, and/or another UE, as described herein with respect to the operations 700. At 904, a modem 126 of the first UE 120a may query the application processor for geographic information, which provides the location of the UE. At 906, the application processor 124 may provide the geographic information to the modem 126. The modem 126 may generate a virtual network signaling value (e.g., NS_33 and/or NS_34) based on the UE's location and provide the virtual networking signaling value to an RF transceiver 128 of the first UE 120a. The modem 126 may call the transceiver's API via a protocol stack to provide the virtual network signaling value. At 910, the RF transceiver 128 may determine the maximum output power based at least in part on an A-MPR derived from the virtual network signaling value, for example, according to Expression (1) or a similar expression for 5G NR systems. Optionally, at 912, the modem 126 may perform power scaling based on the geographic information. At 914, the RF transceiver 128 may update the TX data to include the maximum output power determined at 910. At 916, the RF transceiver 128 may a signal at a transmit power in compliance with the maximum output power determined at 910.

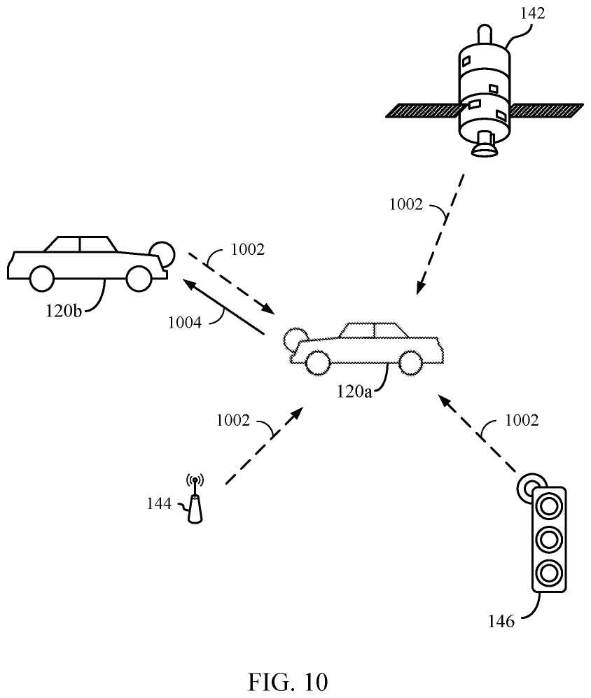

FIG. 10 is a diagram illustrating examples of location sources for a UE to use in determining its location, in accordance with certain aspects of the present disclosure. In this example, the first UE 120a may obtain location information 1002 from one or more location source(s), such as a global navigation satellite system 142, an access point 144 in a WLAN, an RSU 146, and/or another UE 120b, for example, as described herein with respect to the operations 700. The first UE 120a may transmit a signal 1004 at a transmit power in compliance with a maximum output power derived using the location information, as described herein with respect to the operations 700. Those of skill in the art will understand that the location sources illustrated in FIG. 10 are exemplary only. Other types of location sources may be used in addition to or instead of those illustrated.

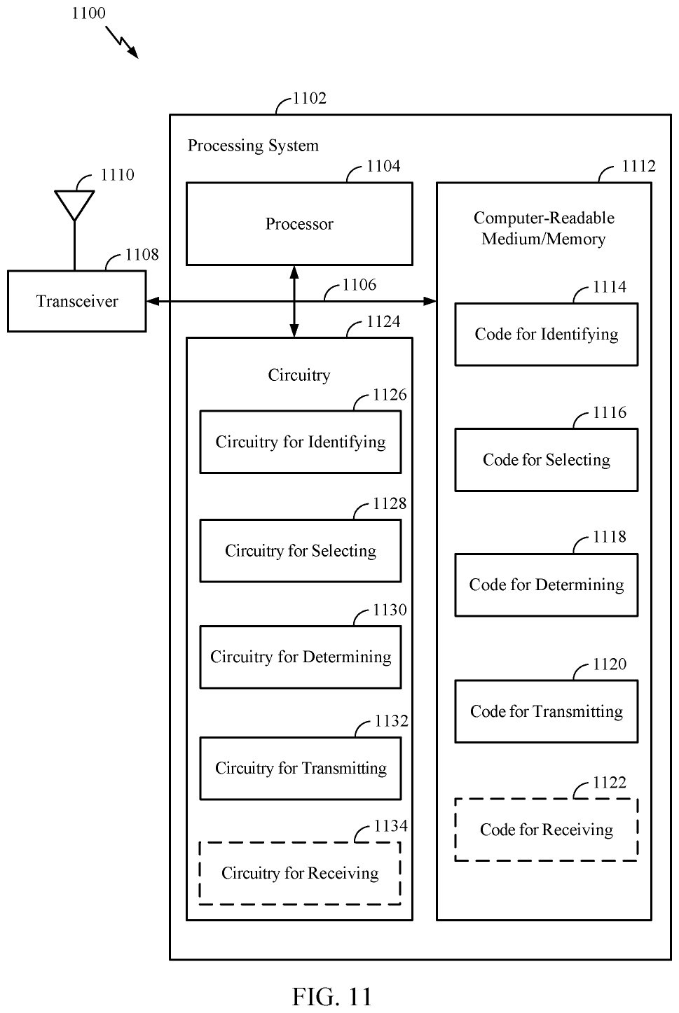

FIG. 11 illustrates a communications device 1100 that may include various components (e.g., corresponding to means-plus-function components) configured to perform operations for the techniques disclosed herein, such as the operations illustrated in FIG. 7. The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes a processor 1104 coupled to a computer-readable medium/memory 1112 via a bus 1106. In certain aspects, the computer-readable medium/memory 1112 is configured to store instructions (e.g., computer-executable code) that when executed by the processor 1104, cause the processor 1104 to perform the operations illustrated in FIG. 7, or other operations for performing the various techniques discussed herein for geography-based transmit power backoff. In certain aspects, computer-readable medium/memory 1112 stores code for identifying 1114, code for selecting 1116, code for determining 1118, code for transmitting 1120, and/or code for receiving 1122. In certain aspects, the processing system 1102 has circuitry 1124 configured to implement the code stored in the computer-readable medium/memory 1112. In certain aspects, the circuitry 1124 is coupled to the processor 1104 and/or the computer-readable medium/memory 1112 via the bus 1106. For example, the circuitry 1124 includes circuitry for identifying 1126, circuitry for selecting 1128, circuitry for determining 1130, circuitry for transmitting 1132, and/or circuitry for receiving 1134.

For example, means for transmitting (or means for outputting for transmission) may include antenna(s) 252 of the UE 120a illustrated in FIG. 2 and/or antenna 1110, transceiver 1108, and/or circuitry for transmitting 1132 of the communication device 1100 in FIG. 11. Means for receiving (or means for obtaining) may include antenna(s) 252 of the UE 120a illustrated in FIG. 2 and/or antenna 1110, transceiver 1108, circuitry for receiving 1134 of the communication device 1100 in FIG. 11. Means for communicating may include a transmitter, a receiver or both. Means for identifying, means for selecting, means for determining, and/or means for generating may include a processing system, which may include one or more processors, such as the receive processor 258, the transmit processor 264, the TX MIMO processor 266, and/or the controller/processor 280 of the UE 120a illustrated in FIG. 2, the circuitry for identifying 1126, the circuitry for selecting 1128, the circuitry for determining 1130 and/or the processing system 1102 of the communication device 1100 in FIG. 11.

### Example Aspects

In addition to the various aspects described above, specific combinations of aspects are within the scope of the disclosure, some of which are detailed below:

Aspect 1: A method of wireless communication by a user equipment (UE), comprising: identifying a region in which the UE is located; selecting a first maximum power reduction value associated with the region; determining a transmit power for a signal based at least in part on the selected first maximum power reduction value; and transmitting the signal at the transmit power.

Aspect 2: The method of Aspect 1, wherein determining the transmit power comprises: determining a low value for a maximum output power based at least in part on a second maximum power reduction value and the first maximum power reduction value; determining a high value for the maximum output power; selecting the maximum output power within the low value and the high value; and determining the transmit power based at least in part on the selected maximum output power.

Aspect 3: The method according to any one of Aspects 1 or 2, wherein the first maximum power reduction value includes a network signaling value and a region specific value.

Aspect 4: The method according to any one of Aspects 1-3, wherein identifying the region comprises: receiving, from an access point, a signature associated with the access point; mapping the signature to a location of the access point; and identifying the region based at least in part on the location of the access point.

Aspect 5: The method of Aspect 4, wherein receiving from the access point comprises receiving the signature from the access point via a wireless local area network.

Aspect 6: The method according to any one of Aspects 1-5, wherein identifying the region comprises: receiving signals from a global navigation satellite system; identifying a location of the UE based on the received signals; and identifying the region based on the location of the UE.

Aspect 7: The method according to any one of Aspects 1-6, further comprising: generating a virtual network signaling value associated with the region; providing the virtual network signaling value to a transceiver; and wherein selecting the first maximum power reduction value comprises selecting, with the transceiver, the first maximum power reduction value based on the virtual network signaling value.

Aspect 8: The method according to any one of Aspects 1-7, further comprising: updating the first maximum power reduction value in response to a change in location of the UE; determining another transmit power for another signal based at least in part on the updated first maximum power reduction value; and transmitting the other signal at the other transmit power.

Aspect 9: The method according to any one of Aspects 1-8, wherein transmitting the signal comprises transmitting the signal to another UE using cellular vehicle-to-everything (CV2X) communications.

Aspect 10: An apparatus for wireless communication, comprising: a memory; a processor coupled to the memory, the processor and the memory being configured to: identify a region in which the apparatus is located, select a first maximum power reduction value associated with the region, and determine a transmit power for a signal based at least in part on the selected first maximum power reduction value; and a transceiver configured to transmit the signal at the transmit power.

Aspect 11: The apparatus of Aspect 10, wherein the processor and the memory are further configured to: determine a low value for a maximum output power based at least in part on a second maximum power reduction value and the first maximum power reduction value; determine a high value for the maximum output power; select the maximum output power within the low value and the high value; and determine the transmit power based at least in part on the selected maximum output power.

Aspect 12: The apparatus according to any one of Aspects 10 or 11, wherein the first maximum power reduction value includes a network signaling value and a region specific value.

Aspect 13: The apparatus according to any one of Aspects 10-12, wherein: the transceiver is further configured to receive, from an access point, a signature associated with the access point; and the processor and the memory are further configured to: map the signature to a location of the access point; and identify the region based at least in part on the location of the access point.

Aspect 14: The apparatus of Aspect 13, wherein the transceiver is configured to receive the signature from the access point via a wireless local area network.

Aspect 15: The apparatus according to any one of Aspects 10-14, wherein: the transceiver is further configured to receive signals from a global navigation satellite system; and the processor and the memory are further configured to: identify a location of the apparatus based on the received signals, and identify the region based on the location of the apparatus.

Aspect 16: The apparatus according to any one of Aspects 10-15, wherein the processor and the memory are further configured to: generate a virtual network signaling value associated with the region, provide the virtual network signaling value to a transceiver, and select, with the transceiver, the first maximum power reduction value based on the virtual network signaling value.

Aspect 17: The apparatus according to any one of Aspects 10-16, wherein: the processor and the memory are further configured to: update the first maximum power reduction value in response to a change in location of the UE, and determining another transmit power for another signal based at least in part on the updated first maximum power reduction value; and transmitting the other signal at the other transmit power.

Aspect 18: The apparatus according to any one of Aspects 10-17, wherein the transceiver is configured to transmit the signal to a user equipment using cellular vehicle-to-everything (CV2X) communications.

Aspect 19: An apparatus, comprising means for performing a method in accordance with any one of Aspects 1-9.

Aspect 20: A computer-readable medium comprising executable instructions that, when executed by one or more processors of an apparatus, cause the apparatus to perform a method in accordance with any one of Aspects 1-9.

Aspect 21: A computer program product embodied on a computer-readable storage medium comprising code for performing a method in accordance with any one of Aspects 1-9.

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another. In other words, unless a specific order of steps or actions is specified, the order and/or use of specific steps and/or actions may be modified.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, a digital signal processor (DSP), an application specific integrated circuit (ASIC), or a processor (e.g., a general purpose or specifically programmed processor). Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above can also be considered as examples of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 7.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above.

1. A method of wireless communication by a user equipment (UE), comprising:
identifying a region in which the UE is located;
selecting a first maximum power reduction value associated with the region;
determining a transmit power for a signal based at least in part on the selected first maximum power reduction value; and
transmitting the signal at the transmit power.

2. The method of claim 1, wherein determining the transmit power comprises:
determining a low value for a maximum output power based at least in part on a second maximum power reduction value and the first maximum power reduction value;
determining a high value for the maximum output power;
selecting the maximum output power within the low value and the high value; and
determining the transmit power based at least in part on the selected maximum output power.

3. The method according to claim 1, wherein the first maximum power reduction value includes a network signaling value and a region specific value.

4. The method according to claim 1, wherein identifying the region comprises:
receiving, from an access point, a signature associated with the access point;
mapping the signature to a location of the access point; and
identifying the region based at least in part on the location of the access point.

5. The method of claim 4, wherein receiving from the access point comprises receiving the signature from the access point via a wireless local area network.

6. The method according to claim 1, wherein identifying the region comprises:
receiving signals from a global navigation satellite system;
identifying a location of the UE based on the received signals; and
identifying the region based on the location of the UE.

7. The method according to claim 1, further comprising:
generating a virtual network signaling value associated with the region; and
providing the virtual network signaling value to a transceiver, wherein selecting the first maximum power reduction value comprises selecting, with the transceiver, the first maximum power reduction value based on the virtual network signaling value.

8. The method according to claim 1, further comprising:
updating the first maximum power reduction value in response to a change in a location of the UE;
determining another transmit power for another signal based at least in part on the updated first maximum power reduction value; and
transmitting the other signal at the other transmit power.

9. The method according to claim 1, wherein transmitting the signal comprises transmitting the signal to another UE using cellular vehicle-to-everything (CV2X) communications.

10. An apparatus for wireless communication, comprising:
a memory;
one or more processors coupled to the memory, the one or more processors and the memory being configured to:
identify a region in which the apparatus is located,
select a first maximum power reduction value associated with the region, and
determine a transmit power for a signal based at least in part on the selected first maximum power reduction value; and
a transceiver configured to transmit the signal at the transmit power.

11. The apparatus of claim 10, wherein the one or more processors and the memory are further configured to:
determine a low value for a maximum output power based at least in part on a second maximum power reduction value and the first maximum power reduction value;
determine a high value for the maximum output power;
select the maximum output power within the low value and the high value; and
determine the transmit power based at least in part on the selected maximum output power.

12. The apparatus according to claim 10, wherein the first maximum power reduction value includes a network signaling value and a region specific value.

13. The apparatus according to claim 10, wherein:
the transceiver is further configured to receive, from an access point, a signature associated with the access point; and
the one or more processors and the memory are further configured to:
map the signature to a location of the access point; and
identify the region based at least in part on the location of the access point.

14. The apparatus of claim 13, wherein the transceiver is configured to receive the signature from the access point via a wireless local area network.

15. The apparatus according to claim 10, wherein:
the transceiver is further configured to receive signals from a global navigation satellite system; and
the one or more processors and the memory are further configured to:
identify a location of the apparatus based on the received signals, and
identify the region based on the location of the apparatus.

16. The apparatus according to, wherein the one or more processors and the memory are further configured to:
generate a virtual network signaling value associated with the region,
provide the virtual network signaling value to a transceiver, and
select, with the transceiver, the first maximum power reduction value based on the virtual network signaling value.

17. The apparatus according to, wherein:
the one or more processors and the memory are further configured to:
update the first maximum power reduction value in response to a change in location of the UE, and
determining another transmit power for another signal based at least in part on the updated additional maximum power reduction value; and
transmitting the other signal at the other transmit power.

18. The apparatus according to claim 10, wherein the transceiver is configured to transmit the signal to a user equipment using cellular vehicle-to-everything (CV2X) communications.
